(19) United States
(12) Patent Application Publication
(10) Pub. No.: US 2026/0294738 A1
(43) Pub. Date: Oct. 1, 2026

(54) DEVICES FOR REHABILITATION AND THE PROPHYLAXIS OF MUSCULOSKELETAL DISEASES

(71) Applicants: Anatoly Vladimirovich SHEVTSOV, Saint Petersburg (RU); Vladimir Igorevich IVLEV, Saint Petersburg (RU)

(72) Inventors: Anatoly Vladimirovich SHEVTSOV, Saint Petersburg (RU); Vladimir Igorevich IVLEV, Saint Petersburg (RU)

(21) Appl. No.: 19/474,819

(22) PCT Filed: Nov. 13, 2023
(86) PCT No.: PCT/RU2023/050264

§ 371 Date: Oct. 13, 2025

(30) Foreign Application Priority Data
May 12, 2023 (RU) 2023112252

(51) Int. Cl. A61H 39/04

(52) U.S. Cl. CPC A61H 39/04; A61H 2205/081

(57) ABSTRACT

A set of devices for physical rehabilitation and the prophylaxis of musculoskeletal diseases comprises a device for physical rehabilitation and the prophylaxis of musculoskeletal diseases and at least one replaceable fastening platform. Said device is designed in the form of a box-shaped body and a base with a protuberance in the centre part thereof, the base being in the form of a detachable panel. On a lateral part of the body are a first pair of massaging protuberances having working surfaces in the form of parabolic cylinders with internal blind bores, and an individual massaging protuberance in the form of a spherical cylinder. On the upper part of the body is a second pair of massaging protuberances which have a tetragonal pyramidal shape, giving rise to a trough therebetween which has a symmetrical medial eminence and a lateral decline.

### TECHNICAL FIELD

The invention relates to technical means for physical rehabilitation, physical culture, health-improving and adaptive physical culture and can be used in healthcare institutions in a medical rehabilitation system, in health-improving programs at fitness centers, in recovery programs at all stages of training and competition in amateur and elite sports, as well as in home physical rehabilitation.

### BACKGROUND OF THE INVENTION

A variety of means with similar applications is known from the prior art.

For example, RU 168180 (published on 23 Jan. 2017) discloses a device for acting on bioactive points of the body and relieving the paravertebral muscles of the spine, which is implemented as a base comprising two pairs of massaging protrusions for correction of the paravertebral muscles of the thoracic and lumbar parts of the spine and one pair of protrusions for reflex-acupuncture action on the neck area and bioactive points of the body. The protrusions are made as a pyramid having a rounded top, and there are recesses between the protrusions for receiving the bony processes of the vertebrae, and the distance between the protrusions of each pair increases from the reflex-acupuncture protrusions for the neck to the massaging protrusions for the lower back, with the reflex-acupuncture pair of protrusions being equipped with spikes.

RU 2003319 (published on 30 Nov. 1993) discloses a device that contains a base having a pair of massaging elements located on its upper part. The massaging elements are prismatic-shaped protrusions having rounded edges and top, the distance between which corresponds to the boundaries of the paravertebral region of the thoracic and lumbar parts of the spine. The edges of the prismatic-shaped protrusions facing each other are connected to each other by a curved surface, and the lower part of the base is convex and consists of two intersecting flat surfaces with a rounded intersection edge.

The closest analogue of the invention is disclosed in RU 2218906 (published on 20 Dec. 2003), which describes a device comprising a box-shaped body and a convex base formed by two flat surfaces adjoining each other. The edge along which the flat surfaces adjoin each other is rounded. On the later part of the body, there are a first pair of massaging protrusions having cylindrical working surfaces, the distance between which corresponds to the boundaries of the paravertebral region of the cervical part of the spine, and a single cylindrical massaging protrusion having a hemispherical working surface. On the upper part of the body, there is a second pair of prismatic massaging protrusions having rounded edges. The distance between the upper edges corresponds to the boundaries of the paravertebral region of the thoracic and lumbar parts of the spine.

The disadvantages of the above-mentioned known devices are their limited use to the back and neck areas without taking into account the individual characteristics of a patient and rehabilitation cases, as well as their short service life with constant use.

### SUMMARY OF THE INVENTION

The objective of the invention is to eliminate the above-mentioned disadvantages.

The technical result is the expansion of the arsenal of technical means in this field, versatility of application and expansion of the possibilities of physical rehabilitation, taking into account individual functional characteristics in the spinal-motor segments, the characteristics of the physiological curves of the spinal column, the age and height-weight characteristics of persons using this rehabilitation device, by applying the relaxation, correction and decompression properties of the device not only to the back and neck, but also to the upper and lower limbs, pelvic area and hip joints, chest, and abdominal area to correct visceral dysfunctions.

In addition, the service life is increased, the weight of the device is reduced while its strength is increased, and the massage effectiveness and safety during use are improved.

The claimed technical result is achieved through the use of a kit for physical rehabilitation and prevention of musculoskeletal disorders, which comprises a device for physical rehabilitation and prevention of musculoskeletal disorders and at least one removable fixing platform, wherein the kit for physical rehabilitation and prevention of musculoskeletal disorders is implemented as:
a box-shaped body and a base, the base having a protrusion in its central part and being made as a removable panel;
a lateral part of the body has a first pair of massaging protrusions having working surfaces that are made as parabolic cylinders having internal blind holes, and a single massaging protrusion made as a spherical cylinder;
an upper part of the body has a second pair of massaging protrusions shaped as a tetrahedral pyramid having rounded edges and a rounded top, giving rise to a hollow therebetween which has a symmetrical medial elevation and lateral depression;
and the removable fixing platform is designed to fix the device for physical rehabilitation and prevention of musculoskeletal disorders thereon, has a box-shaped form with an open upper part and a hollow in a central part of a bottom, whose shape and dimensions correspond to the shape and dimensions of the protrusion on the base of the device for physical rehabilitation and prevention of musculoskeletal disorders.

The device for physical rehabilitation and prevention of musculoskeletal disorders allows one to influence the spinal-motor segments and the periarticular tissues of large joints; and removable fixing platforms of different heights allow one to select an individual dosed degree of influence of the massaging and correction protrusions.

To increase strength, the internal volume of the device for physical rehabilitation and prevention of musculoskeletal disorders is reinforced with three ribs. The central rectangular rib is located centrally and connected to the inner part of the hollow. The two lateral ribs are symmetrical to the central rib and close to the lateral faces of the body, made as an irregular hexagon and have a pair of cylindrical legs with holes for fixing connecting elements of the removable base therein.

Depending on the individual anatomical and morpho-functional characteristics of the spinal-motor segments, the degree of tension in the paravertebral tissues, vertebral torsion, the presence of scoliosis and other posture disorders, a rehabilitation specialist, based on the parameters obtained as a result of functional diagnostics, radiological diagnostics, biomechanical and anthropometric research methods, determines the depth of the hollow formed by the height of the second pair of massaging protrusions (in the range from 1 to 10 cm) in the form of tetragonal pyramids consisting of unequal-sided triangles with smooth edges that provide fixing rigidity. This hollow is designed for segmental placement of the spinal-motor segment. Compared to the protrusions of the closest analogue, the proposed protrusions have a customized angle between the inner surfaces of the faces of the tetrahedral pyramids, from 20° to 110°, which is determined by the rehabilitation specialist based on the parameters obtained as a result of functional diagnostics, radiological diagnostics, biomechanical and anthropometric research methods for more accurate orthopaedical rehabilitation correction. The surfaces of the faces have individual physical properties (smooth or rough) taking into account the individual skin sensory system. The radii of vertex rounding have been customized (the radius was 19 mm, and now ranges from 10 mm to 80 mm), and the radii of rounding between the adjacent faces of tetrahedrons have been reduced (the radius was 26 mm, and now ranges from 15 mm to 80 mm), which ensures the main rehabilitation principle—the principle of gradualness. In this case, such a range of the individually calculated device shape with specified radius parameters ensures non-traumatic and painless penetration of the device protrusions into the muscle-fascial tissues of the paravertebral zone of the spinal-motor segments, expanding the rehabilitation capabilities of the device when used in physical rehabilitation. The features of this design allow for more precise functional mobilization in each spinal-motor segment and, when used correctly, produce a unique biomechanical effect of simultaneous segmental relaxation, mobilization and traction, without disrupting the statokinetic stability of a specific spinal-motor segment and the musculoskeletal system as a whole.

The massaging protrusion made as a spherical cylinder is designed to expand the rehabilitation capabilities of this device. This protrusion is used to perform acupressure point massage in static and dynamic modes, and it is also necessary for installing the device and for gripping and subsequently moving it under the back during rehabilitation physical exercises. The height of the spherical cylinder and parabolic cylinders in the range from 1 to 7 cm is determined by the rehabilitation specialist using functional diagnostics, radiological diagnostics, biomechanical and anthropometric research methods. Important factors in selecting the height of the spherical cylinder and parabolic cylinders are the age of the patient, height and weight parameters, the presence of degenerative-dystrophic disorders, and the presence of myofascial pain syndrome in the cervical part of the spine. The selection of the height of the spherical cylinder in the range from 4 to 7 cm depends on the segmental zone of massage action on the muscle-fascial tissues. The more voluminous the muscle-fascial tissues, the deeper the penetration of the protrusions is implied, up to the tendon attachments of the muscles to the anatomical bone formations. Flattened superficial muscle-fascial tissues do not require deep pressure treatment. Therefore, the height of the spherical cylinder for such tissues can range from 1 to 3 cm, depending on the topography of application and anatomical factors. It is important to consider the age of the patient when selecting the height of the spherical cylinder. A decrease in the height (1-3 cm) of the spherical cylinder is directly related to a decrease in biological age and reduced physical development parameters (for example, children aged 7 to 14 years need a reduced height in the range of 1 to 3 cm). A reduction in the height (1-3 cm) is also recommended for elderly people over 65 years of age due to progressive degenerative-dystrophic disorders of the musculoskeletal system. A reduction in the height of the spherical cylinder, as determined by the specialist conducting the rehabilitation measures, may be associated with increased pain sensitivity of the patient, the presence of myofascial pain syndrome, and for the purposes of a phased physical rehabilitation program. The selection of the height of the spherical cylinder in the direction of increase (from 4 to 7 cm) is determined as the myofascial pain syndrome decreases or disappears, the range of motion in the flexible joints of the musculoskeletal system increases, and tension in the rehabilitated tissues decreases.

The distance between the centers of the parabolic cylinders is 2 to 7 cm, and the distance from the center of the spherical cylinder to the center of the nearby parabolic cylinder is 6 to 9 cm. The distance is determined by the rehabilitation specialist based on the parameters obtained as a result of functional diagnostics, radiological diagnostics, biomechanical and anthropometric research methods for more accurate orthopaedical rehabilitation correction. The distance between the centers of the parabolic cylinders is determined by the rehabilitation specialist based on anthropometric measurements of the patient's neck circumference. The recommended parameters are as follows:
neck circumference from 28 to 32 cm—distance 2 cm;
neck circumference from 33 to 35 cm—distance 3 cm;
neck circumference from 36 to 38 cm—distance 4 cm;
neck circumference from 39 to 41 cm—distance 5 cm;
neck circumference from 42 to 47 cm—distance 6 cm;
neck circumference from 48 to 52 cm—distance 7 cm.

The distance between the centers of the parabolic cylinders and the center of the spherical cylinder to the center of the nearby parabolic cylinder correlates and depends on the distance between the centers of the parabolic cylinders. Increasing the distance between the centers of the parabolic cylinders reduces the distance from the center of the spherical cylinder to the center of the nearby parabolic cylinder on the lateral surface of the device for physical rehabilitation and prevention of musculoskeletal disorders.

The two massaging protrusions in the form of adjacent parabolic cylinders are designed for restorative correction in the spinal-motor segments of the cervical part of the spine. These protrusions also allow the device to be gripped and moved under the back during rehabilitation physical exercises and have ergonomic holes for easy gripping with the fingers. The protrusions allow for effective massage and self-massage procedures, providing myofascial release throughout the body. The non-through holes of the parabolic cylinders are reinforced at the center by internal partitions.

The base has a central internal angle on the inner surface of the panel ranging from 180° to 150°. The central internal angle is determined by the rehabilitation specialist, taking into account the use of balancing and rotational physical exercises in the methodology. A decrease in the degree of the central internal angle from 180° to 150° corresponds to an increase in the complexity of balancing physical exercises and an increase in the degree of rotation in the spinal-motor segments. As tests have shown, these angular parameters correspond to the anatomical and biomechanical ranges of the static and dynamic capabilities of the spinal-motor segments in balancing, static-pressure, rotational techniques of segmental mobilization and does not allow the recurrence of existing spinal diseases during physical rehabilitation and microtraumatic damage to paravertebral tissues and neurovascular anatomical structures. This protrusion allows one to eliminate functional disorders of the spinal-motor segments by performing rotational physical exercises at different angles of the device. The curved shape of the protrusion allows one to perform balancing, static-pressure and rotational physical exercises aimed at improving the coordination of the musculoskeletal system. The base with the protrusion can also be used for massage and self-massage of the abdomen, chest, upper and lower limbs using dynamic and static myopressure techniques.

The distance from the central rib to the lateral ribs is from 2 cm to 7 cm.

The lateral faces of the body additionally contain supports in the form of rectangular posts, which simultaneously reinforce the lateral faces of the device and secure the removable curved panel.

Depending on individual rehabilitation needs, individual characteristics of the musculoskeletal system, body tissue tension, the presence or absence of the myofascial pain syndrome associated with vertebrogenic disorders, the device can have a specified hardness of the entire structure and individual components on the Shore A hardness scale (ranging from 10 Shore A to 100 Shore A), as well as be manufactured according to individual specified parameters in the form of solid structures made of various materials and manufactured in various ways from wood materials.

The kit may further comprise six removable fixing platforms, i.e. the kit may comprise a total of seven removable fixing platforms.

The inclusion of removable fixing platforms in the kit, together with the device for physical rehabilitation and prevention of musculoskeletal disorders, allows for the maximum number of rehabilitation cases to be treated, taking into account individual functional characteristics in the spinal-motor segments, the characteristics of the physiological curves of the spinal column, and the age and height-weight characteristics of persons using this rehabilitation device. The use of the removable fixing platforms allows one to expand the possibilities of physical rehabilitation and apply the relaxation, correction and decompression properties of the device not only to the back and neck, but also to the upper and lower extremities, the pelvic area and hip joints, chest, and abdominal area for the correction of visceral dysfunctions. The kit allows one to eliminate functional blocks sequentially in each spinal-motor segment, starting from the upper cervical level and ending with the lower lumbar and sacrococcygeal levels, while increasing the distance between each vertebra to the level of biomechanical norm and eliminating bone and cartilage deformities and muscle-tonic asymmetries.

### BRIEF DESCRIPTION OF THE DRAWINGS

This invention is illustrated by the drawings in which:

FIG. 1 shows a general view of a kit which includes a device for physical rehabilitation and prevention of musculoskeletal disorders and a set of seven interchangeable fixing platforms;

FIG. 2 shows a general view of the device;

FIG. 3 shows a side view of the device;

FIG. 4 shows a top view of the device;

FIG. 5 shows a view of the device with its base removed;

FIG. 6 shows a general view of the base;

FIG. 7 shows a top view of the internal volume of a body;

FIG. 8 shows a side view of the body with the base removed;

FIG. 9 shows a general view of the removable fixing platform;

FIG. 10 shows an embodiment of the device manufactured, according to individual specifications, in the form of solid structures made of various materials;

FIG. 11 shows an embodiment of the device manufactured, according to individual specifications, from wood materials.

### DETAILED DESCRIPTION OF THE INVENTION

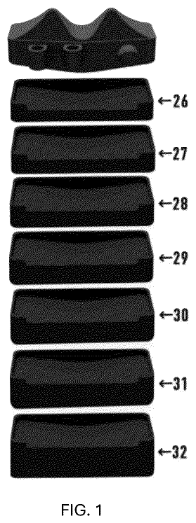

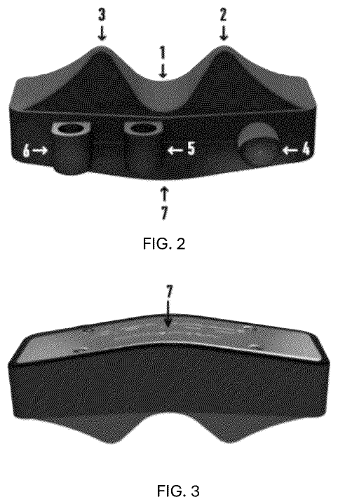

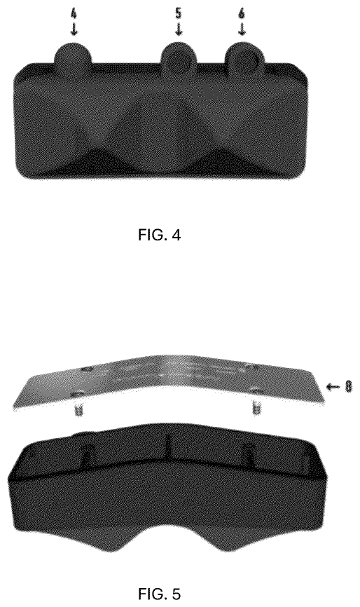

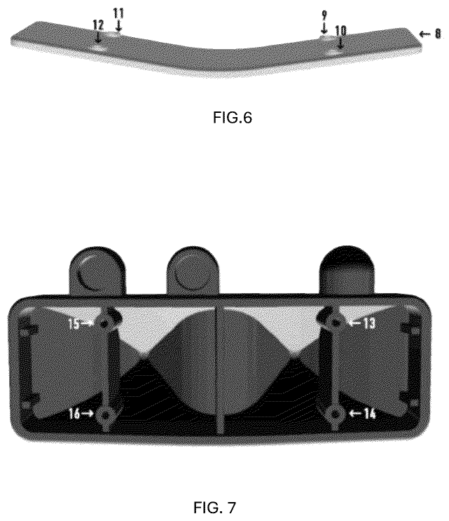

As shown in FIG. 1, a kit comprises a device for physical rehabilitation and prevention of musculoskeletal disorders and a set of removable fixing platforms 26, 27, 28, 29, 30, 31, 32 (in this example, there are seven of them). The device for physical rehabilitation and prevention of musculoskeletal disorders is a complex geometric structure with seven specially designed protrusions 1-7 of a specific geometric shape. The device for physical rehabilitation and prevention of musculoskeletal disorders has a hollow 1 at the center with a symmetrical medial elevation and lateral depression.

On one of the longitudinal surfaces of the device for physical rehabilitation and prevention of musculoskeletal disorders, there are three specially shaped massaging protrusions 4, 5, 6. The protrusion 4 is shaped as a terminal spherical cylinder having a height of 1 to 7 cm, and the other two protrusions are shaped as parabolic adjacent cylinders 5, 6 having internal blind holes reinforced by internal partitions at the center with the same height as the terminal spherical cylinder. The distance from the center of the spherical cylinder 4 to the center of the parabolic cylinder 5 is from 6 to 9 cm. The protrusion made as the spherical cylinder is designed to expand the rehabilitation capabilities of this device. The protrusion 4 performs acupressure point massage in static and dynamic modes. It is also necessary for installing the device and for gripping and subsequently moving it under the back during rehabilitation physical exercises. The two parabolic adjacent cylinders 5 and 6 are designed for restorative correction in the spinal-motor segments of the cervical part of the spine. These protrusions 5, 6 also allow the device to be gripped and moved under the back during rehabilitation physical exercises and have ergonomic holes for convenient gripping of the device with the fingers. The protrusions 5, 6 allow effective massage and self-massage procedures to be performed, providing myofascial release throughout the body.

The protrusion 7 is a removable curved panel 8 that is fixed to the lower surface of the device with four self-tapping screws with countersunk heads. The curved panel 8 has an individually calculated central internal angle on the inner surface of the panel from 180° to 150° and holes with beveled projections 9, 10, 11, 12 on the inside, ensuring tight and even contact with cylindrical legs 13, 14, 15, 16 located on the lateral ribs and fixed with self-tapping screws. This protrusion 7 allows one to eliminate functional disorders of the spinal-motor segments by performing rotational exercises at different angles of the device. The curved shape of the protrusion 7 allows one to perform balancing physical exercises aimed at improving the coordination of the musculoskeletal system. This panel 8 with the protrusion 7 can also be used for massage and self-massage in the abdomen, chest, upper and lower extremities, and in dynamic and static myopressure techniques.

The inside of the device is hollow and has three stiffening ribs 17, 18, 19, which makes the structure both lightweight and strong. The rectangular rib 18 located at the center and connected at the bottom to the hollow 1 provides biomechanical centering for high-precision rehabilitation decompression of the spinal-motor segments. The lateral ribs, which are made as an irregular hexagon 17, 19 with paired cylindrical legs 13, 14, 15, 16 and close to the lateral faces of the device, are symmetrically and equidistantly located at a distance from the central rib 18 in the range from 2 cm to 7 cm and are designed to create balance. The cylindrical legs 13, 14, 15, 16 affect the balance of the left and right sides of the device to ensure a synergistic effect on the left and right paravertebral zones in the spinal-motor segments. These cylindrical legs enhance the stability of the overall structure of the device, as the absence of these legs during modelling has demonstrated a lack of the necessary balance between the left and right sides of the device and led to excessive displacement during rehabilitation physical exercises, which could lead to an inadequate effect with a traumatic effect and an increase in the lateral sides of the protruding projections 2, 3. The cylindrical legs 13, 14, 15, 16 are designed to reinforce the original geometric structure, create balance to ensure biomechanical correction of the spine and surrounding muscles, and have threaded holes for self-tapping screws and fixing the removable curved base 8. The supports in the form of rectangular posts 20, 21, 22, 23 are located on the inside of the side walls of the body and simultaneously reinforce the lateral faces of the device and secure the removable curved panel 8.

The projections 2, 3, which are shaped as a tetragonal pyramidal, consist of unequal-sided triangles with surfaces having individual physical properties (smooth or rough) and provide the fixing rigidity of the structure of the device for physical rehabilitation and prevention of musculoskeletal disorders, are designed for biomechanical correction of the spinal-motor segments of the thoracic and lumbosacral parts of the spinal column, periarticular tissues of large joints, chest, abdomen, upper and lower extremities, and pelvic area. The geometric shape of the protrusions 2, 3, which is specially calculated taking into account anatomical parameters, allows for a unique biomechanical effect of simultaneous relaxation of the paravertebral muscle group in a specific segment and an effect of segmental traction, spreading two adjacent vertebrae and opening the facet joints to physiological and biomechanical norms. The rehabilitative effect of the protrusions 2, 3 on the periarticular tissues of large joints is achieved by myopressure and individually designed physical exercises. The rehabilitative effect of the projections 2, 3 on the chest is achieved from different body positions (lying face down on the device with the chest on the device, lying on the back and in a sitting position, working on the intercostal spaces). The rehabilitative effect of the protrusions 2, 3 on the abdomen is carried out by installing the protrusions in a specific methodological sequence and with individual exposure in a prone position and supine position, performing abdominal massage in a specific methodological sequence and with the individual exposure. The rehabilitative effect of the protrusions 2, 3 on the upper and lower limbs is carried out by placing the protrusions segmentally and performing massage pressure actions in both static and dynamic modes with various physical exercises. The rehabilitative effect of the protrusions 2, 3 in the pelvic region allows for segmental static-dynamic pressure to be applied to the sacrum and deep pelvic muscles, including the periarticular tissues of the hip joints. These protrusions 2, 3 are installed alternately in key segments in the area of the transverse processes of the vertebral bodies. These protrusions 2, 3 can also be used for massage with a rehabilitation specialist and for self-massage at home in the abdomen, chest, upper and lower limbs using dynamic and static myopressure techniques and myofascial release throughout the body.

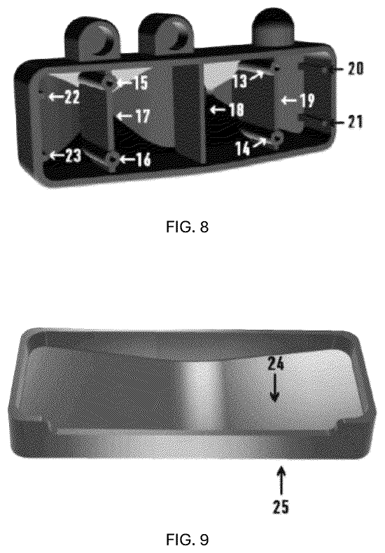

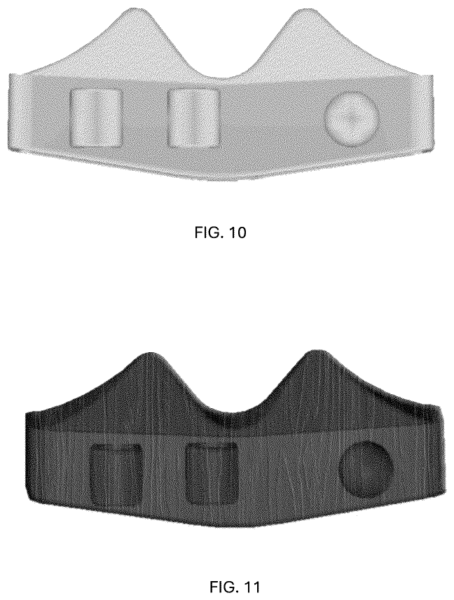

Each removable fixing platform (FIG. 9) is a rectangular parallelepiped having two contact surfaces. The outer surface 25 of the bottom face has a flattened shape. The inner surface 24 of the bottom face of the parallelepiped has a hollow corresponding in shape and dimensions to the protrusion 7 of the base of the device for physical rehabilitation and prevention of musculoskeletal disorders on the spinal-motor segments, the periarticular tissues of large joints and myofascial tissues, as selected by the rehabilitation specialist (FIG. 3). The lateral faces of the removable fixing platforms have a flat rectangular shape on the outer sides. The longitudinal lateral faces of the removable fixing platform are shaped as an elongated pentagon on the inner sides. The transverse lateral faces of the removable fixing platform are shaped as an elongated rectangle on the inner sides. The height of the removable fixing platform from the center of the inner surface of the bottom face is selected from a range of 0.5 cm to 10 cm.

The rehabilitation specialist selects the removable fixing platform from the set of removable fixing platforms based on the parameters obtained as a result of functional diagnostics, radiological diagnostics, biomechanical and anthropometric research methods. The height of the removable fixing platforms enhances the decompression capabilities of the device for physical rehabilitation and prevention of musculoskeletal disorders. The greater the height of the removable fixing platform, the deeper the penetration of the protrusions of the device for physical rehabilitation and prevention of musculoskeletal disorders. Gradually increasing the height of the removable fixing platforms allows for smooth decompression of the spinal-motor segments and anatomically precise elimination of intervertebral disc decentration. The decision to increase the height of the removable fixing platforms is made by the rehabilitation specialist based on positive rehabilitation effects, the achievement of a high level of elasticity in the paravertebral zone, and when a deeper impact on the spinal-motor segment is required. The fixing platforms can be replaced several times even during a single rehabilitation session, when the need arises to strengthen or weaken the impact based on the patient's self-perception. As functional blocks in the spinal-motor segments are unblocked and the myofascial pain syndrome is relieved, the transition from one stage of physical rehabilitation to the next occurs. The removable fixing platform, which is individually selected by the rehabilitation specialist taking into account the anatomical and physiological characteristics of the patient's spinal-motor segments, allows for precise functional contact between the device for physical rehabilitation and prevention of musculoskeletal disorders and the osteochondral and myofascial anatomical structures. An important feature of the removable fixing platforms is the ability to increase the functionality of the penetrating projections of the device for physical rehabilitation and prevention of musculoskeletal disorders into the myofascial tissues of the paravertebral zone as pain is relieved or reduced and the patient's stress index decreases during the course of physical rehabilitation. Changing the height of the removable fixing platform and, accordingly, the entire associated structure allows for customization of the physical rehabilitation process, more precisely creating biomechanical conditions for decompression of facet joints, mobilization of the costovertebral joints, and segmental mobilization and decompression of absolutely all spinal-motor segments of the musculoskeletal system.

The proposed kit for physical rehabilitation and prevention of musculoskeletal disorders, comprising the device for physical rehabilitation and prevention of musculoskeletal disorders and the seven removable fixing platforms, provides unstable balancing (without the fixing platforms) and stable static (with the fixing platforms) positions of the device during physical exercises. The device for physical rehabilitation and prevention of musculoskeletal disorders, when used without the removable fixing platform, allows for balancing physical exercises aimed at improving the coordination of the musculoskeletal system. The device for physical rehabilitation and prevention of musculoskeletal disorders, when used with the removable fixing platforms, creates a stable position during physical exercises, achieving relaxation and traction effects and eliminating trigger points in deep, static muscle structures.

The device for physical rehabilitation and prevention of musculoskeletal disorders is manually inserted into the removable fixing platform. The device for physical rehabilitation and prevention of musculoskeletal disorders is placed within the inner surface of the removable fixing platform until the protrusion 7 is fully engaged (all the way to the stop) within the hollow of the removable fixing platform. Due to its ergonomic shape and elastic structure, the removable fixing platform is easily and securely connected, forming a single rehabilitation structure and creating the necessary conditions for stable support of the device for physical rehabilitation and prevention of musculoskeletal disorders during physical exercises.

1. A kit for physical rehabilitation and prevention of musculoskeletal disorders, comprising:
a device for physical rehabilitation and prevention of musculoskeletal disorders for influencing flexibly connected links of a musculoskeletal system; and
at least one removable fixing platform;
wherein the device for physical rehabilitation and prevention of musculoskeletal disorders is implemented as a box-shaped body and a base, the base having a protrusion in a central part thereof and being made as a removable panel;
wherein a lateral part of the body has a first pair of massaging protrusions having working surfaces that are made as parabolic cylinders having internal blind holes, and a single massaging protrusion made as a spherical cylinder;
wherein an upper part of the body has a second pair of massaging protrusions shaped as a tetrahedral pyramid with rounded edges and a rounded top, giving rise to a hollow therebetween which has a symmetrical medial elevation and lateral depression;
wherein the removable fixing platform is designed to fix the device for physical rehabilitation and prevention of musculoskeletal disorders thereon and has a box-shaped form with an open upper part and a hollow in a central part of a bottom, the hollow having a shape and dimensions corresponding to a shape and dimensions of the protrusion on the base of the device for physical rehabilitation and prevention of musculoskeletal disorders.

2. The kit of claim 1, wherein the body has an internal volume reinforced with three ribs, of which a central rectangular rib is located centrally and connected to an inner part of the hollow, and two lateral ribs are located symmetrically to the central rectangular rib and close to lateral faces of the body, the two lateral ribs being made as an irregular hexagon and having a pair of cylindrical legs with holes for fixing connecting elements of the removable base therein.

3. The kit of claim 1, wherein the hollow has a depth formed by a height of the second pair of massaging protrusions and ranging from 1 to 10 cm.

4. The kit of claim 1, wherein each of the spherical cylinder and the parabolic cylinders has a height ranging from 1 to 7 cm.

5. The kit of claim 1, wherein a distance between centers of the parabolic cylinders ranges from 2 to 7 cm, and a distance from a center of the spherical cylinder to the center of the parabolic cylinder ranges from 6 to 9 cm.

6. The kit of claim 1, wherein the blind holes of the parabolic cylinders are reinforced centrally by internal partitions.

7. The kit of claim 1, wherein the protrusion of the curved base has a central internal angle ranging from 180° to 150°.

8. The kit of claim 1, wherein the body has lateral faces having supports made as rectangular posts.

9. The kit of claim 1, wherein the kit has a hardness ranging from 10 to 100 Shore A.

10. The kit of claim 1, wherein the kit comprises seven removable fixing platforms.
